(19) United States
(12) Patent Application Publication
(10) Pub. No.: US 2026/0205161 A1
(43) Pub. Date: Jul. 16, 2026

(54) WIRELESS COMMUNICATION METHOD BETWEEN AN ACTIVE NFC DEVICE AND SEVERAL PASSIVE NFC DEVICES

(71) Applicant: STMicroelectronics (China) Investment Co., Ltd., Shanghai (CN)

(72) Inventors: Gang WU, Shanghai (CN); Tianhao XIONG, Shanghai (CN)

(73) Assignee: STMicroelectronics (China) Investment Co., Ltd., Shanghai (CN)

(21) Appl. No.: 19/136,784

(22) PCT Filed: Dec. 14, 2022
(86) PCT No.: PCT/CN2022/139005

§ 371 Date: Jun. 6, 2025

(51) Int. Cl. H04B 5/77; G06K 7/10

(52) U.S. Cl. CPC H04B 5/77; G06K 7/10019

(57) ABSTRACT

The present disclosure is directed to a near field communication (NFC) system for efficient activation and reading of a plurality of NFC tags by an NFC reader in a vicinity of the plurality of tags. Each NFC tag of the plurality of NFC tags includes a same identification data corresponding to a reference location.

### BACKGROUND

### Technical Field

The present disclosure is directed to a near field communication (NFC) system.

### Description of the Related Art

In general, near field communication (NFC) systems include a wireless communication link between two or more devices positioned in a limited distance compared with each other. Typically, a communication distance between the NFC devices is less than 20 cm or less than 10 cm, based on the device characteristics. For instance, the NFC devices may be active with power sources to form an active NFC system working in a longer distance compared with a passive NFC system. In the passive NFC system, one or more devices may be passive, without any power source. Although a passive NFC system may operate in a shorter distance limit, it is more energy and cost efficient when comparing with the active NFC system. In a passive NFC system, an active device (e.g., NFC reader or initiator) may wirelessly provide a sufficient energy for the passive devices (e.g., NFC tag or listening device). In such a condition, the passive devices are operating in an energy harvesting mode, where the passive devices are activated by receiving a wireless signal from the active device.

The passive devices may include identification data, e.g., unique identification (UID), which is readable by the active device. In some examples, the passive devices may work in a radiofrequency range as radiofrequency identification (RFID) tags. The active device may communicate with the passive devices through different wireless communication methods, such as backscatter coupling, capacitive coupling, and inductive coupling. In general, capacitive and inductive coupling are desirable for a short-range communication (e.g., several centimeters) while the backscatter coupling is used for a long-range communication (e.g., hundreds of centimeters). In the long-range communication, the active device may communicate with multiple passive devices at the same time. Thus, an interference (collision) between the multiple passive devices may impact data exchanges through the wireless communication link. The collision may cause loss of identification data from the passive devices or generate a time delay of successfully reading out the identification data by the active device.

### BRIEF SUMMARY

The present disclosure is broadly directed to an active near field communication (NFC) reader that is configured to interact with a plurality of passive NFC devices or tags that are in close proximity to each other or otherwise within a vicinity of each other. Each of the NFC devices or tags have a same or substantially similar data stored in their memory. This allows for a significant decrease a processing time of reading and identifying the plurality of tags. The reading time is more efficient because the method avoids or greatly reduces a need for anti-collision detection of the tags.

In particular, the NFC reader is configured to interact with a plurality of tags where the reader is configured to activate a plurality of tags at the same time. This enables a wireless communication method between the active NFC reader or device and several passive NFC devices. The passives NFC devices are located in a close vicinity of each other and store a same item of information in each distinct memory. The method is performed in the reader or device and includes detecting at least one of the several passive NFC devices by sending a read command to all of the passive NFC devices in the vicinity to obtain the item of information of the several passive NFC devices. The method includes receiving at least one response from one of the several passive NFC devices and retrieving the item of information from the one of the several passive NFC devices.

In one example of use or implementation, the present disclosure is directed to a smart parking management system based on a near field communication (NFC) link. A smart parking location is equipped with a plurality of NFC tags. Each NFC tag includes identification data corresponding to the smart parking location. The identification data for the plurality of the NFC tags is the same or substantially the same. In a parking use case, a movable NFC reader is attached to a transporter (e.g., an electrical bike or a scooter or other rentable vehicle) to be parked in the smart parking location. There are a plurality of different smart parking locations available, each with a specific parking location ID. The system is configured to quickly activate a subset of the NFC tags when the transporter is positioned in one of the smart parking locations, receive the specific parking location ID from one of the activated NFC tags, and notifying the user about a validity of the smart parking location when the transporter is positioned in an authorized location, i.e., an acceptable parking location of the transporter.

The NFC readers of the present disclosure are directed to detecting ones of the plurality of NFC tags by transmitting a request signal and receiving one or more returned signals from the NFC tags within a vicinity of each other. The NFC tags may be passive tags that are activated by the request signal. The NFC reader includes a memory or is coupled to a remote server that stores identification data that identify the different authorized locations to be compared with the specific parking location ID read from the NFC tags. The NFC reader can activate more than one tag at the same time. In known NFC systems, such an interference (collision) may prevent a successful detection of the NFC tags. Known NFC systems use a time consuming anti-collision process to determine which of the NFC tags is to be read. This anti-collision process results in a delay in reading the NFC tags due to a multi-step matching identification process.

In contrast, in the present disclosure, the identification data of the plurality of NFC tags is substantially the same. Thus, an anti-collision process may be avoided or implemented less frequently than known systems. The present method will implement an anti-collision process only if an NFC tag with a different identification data is in the vicinity of the NFC reader. As an example in the parking use case, the anti-collision process is only activated if one of the NFC tags in the vicinity of the NFC reader does not have substantially the same identification data of the other NFC tags within the smart parking location. Nevertheless, the NFC reader can process the collision and focus on the NFC tags associated with the smart parking location.

### BRIEF DESCRIPTION OF THE SEVERAL VIEWS OF THE DRAWINGS

Aspects of the present disclosure are best understood from the following detailed description when read with the accompanying figures. It is noted that various features are not necessarily drawn to scale.

FIG. 1 is a flowchart of activating and quickly identifying identification information from a plurality of near field communication (NFC tags) in a vicinity of an NFC reader, in accordance with the present disclosure.

FIG. 2 is an example NFC system of a reader and a tag.

FIG. 3 is a modulation scheme for the NFC system, in accordance with some embodiments.

FIG. 4 is an example of communication waveform in the NFC system, in accordance with some embodiments.

FIG. 5 is a smart parking system for electric bikes that includes a near field communication (NFC) system, in accordance with some embodiments.

FIG. 6 is an alternative configuration of the smart parking system of FIG. 5.

FIG. 7 is an alternative smart parking system for unmanned vehicles.

FIG. 8A an example of communication waveform with a collision in the NFC system, in accordance with some embodiments.

FIG. 8B is an example of communication waveform of reading out multiple tags in the NFC system, in accordance with some embodiments.

### DETAILED DESCRIPTION

The present disclosure is directed to a system and method of more efficiently processing a group of NFC tags that are all within a vicinity or activation area of an NFC reader. The methods of the present disclosure are configured to quickly activate and identify an authorized NFC tag by removing or significantly reducing a need for an anti-collision process. This is achieved by each of the NFC tags having a same or substantially the same item of information stored in a memory.

In known systems, each NFC tag includes a unique ID. Each tag includes a memory, such as n EEPROM that can store user data. To access the user data in the EEPROM, the NFC readers must get the unique ID and then will use the unique ID as a filter to select or address the target tag. This is to avoid a cross read. This uses an anti-collision process to first identify the correct unique ID, then selects the target tag, and then reads the user data. The anti-collision process can take a long period of time.

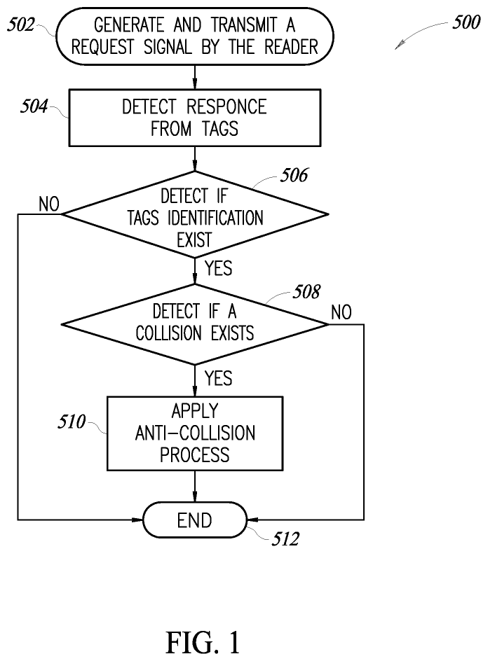

The method and systems of the present disclosure address the challenges of the known systems. For example, FIG. 1 is a flowchart 500 of a process to efficiently detect one or more tags of an NFC system. An NFC reader, such as readers 108, 308 and 430 in the Figures below, is configured to quickly detect an authorized tags in a vicinity of area of the NFC reader. The authorized tags each include the same or substantially the same user data in each of their memories. By include the same or substantially the same (such as within a couple of bits differences) a need for implementing the time consuming anti-collision process is reduced. The method includes an anti-collision process to remove a collision when a non-authorized tag is within the vicinity of the reader. Thus, the anti-collision process is selectively applied only when the collision exists. As a result, a total time of the reading process is reduced from about 500 milliseconds (ms) to less than 10 ms.

It is noted that the unique ID is unique for each tag. The user data stored in tags that are within a vicinity of each other, as determined by an end use, is the same or substantially the same, such as information about parking localization. The read command initiated by the NFC read is for reading the user data, not necessarily the unique ID. This method allows for the “read” command to periodically be sent out, removing the other commands to check for the unique IDs or other tag presence.

At 502, the NFC reader transmits a request signal to a plurality of tags that are in communicable distance or vicinity (based on a NFC communication range). The NFC reader includes a process or control unit that is configured to generate the request signal. The process or is configured to modulate and encode the signal to be transmitted by an antenna of the reader. The request signal includes a command of the reader that is received by a control module of each tag in the vicinity. The signal activates the tag to provide access to the unique ID and the user data from each activated tag.

At 504, the reader detects a response or received signal from the one or more tags. At 506, the processor of the reader analyzes the received signals, after demodulation and decoding, to detect or determine the user data stored in the activated tags. If the received signal does not return authorized user data, then the process ends at 512 or the reader may return to step 502 and send another request signal with different timing slot. In some embodiments, the reader repeats transmitting the request signal in different timing slots (corresponding to number of tags designated to the NFC system) and waits for a period of time to receive signals from the tags. Where no tag is in the vicinity, the reader may repeat transmitting the request signal until a return signal is received from a tags.

At 506, the processor compares the received user data with an inventory stored in a memory of the processor or access in a remote sever, such as through a wireless communication channel. The inventory includes one or more authorized locations or identifiers that is compared to the user data collected from the one or more tags. It is noted that each tag includes a unique ID and the same or substantially the same user data in the tag's memory.

Once the reader has determined or otherwise detected one or more tags, the reader detects if a collision exits at 508. If there is no collision between the detected tags, the processor retrieves the user data stored in the one or more tags in the vicinity. This communication method is for accelerating the retrieval of user data stored in multiple NFC tags. The process bypasses the anti-collision process by sending a read command to all the NFC tags. As all the NFC tags shares the same information in memory, when receiving all the responses, it is possible to retrieve the information relating to the parking area from all the received responses. There is no interference problem in this case as all the tags respond with the same user data.

By assigning the substantially same user data to the plurality of tags, such as tags 110, the inventory may include only the substantially same user data (or a plurality of authorized options, in the use case of parking sytem). Hence, once the reader detects that the user data of one or more tags is matched with the substantially same user data in the inventory, the processor confirms the detection and ends the process. In addition, when multiple tags are detected in a same timing slot and the processor detects a collision, performing the anti-collision process takes a shorter time compared with the conventional methods. For example, during the anti-collision process, the processor compares all the tags in the vicinity of the reader with the user data in the inventory in one timing cycle. Thus, the anti-collision process is not repeated for all the detected tags over many timing cycles. The anti-collision process may only repeat if the detected tag has user data that does not match user data in the inventory of the reader (e.g., unauthorized tags, different brands of tags, and illegal tags or fraudulent tags).

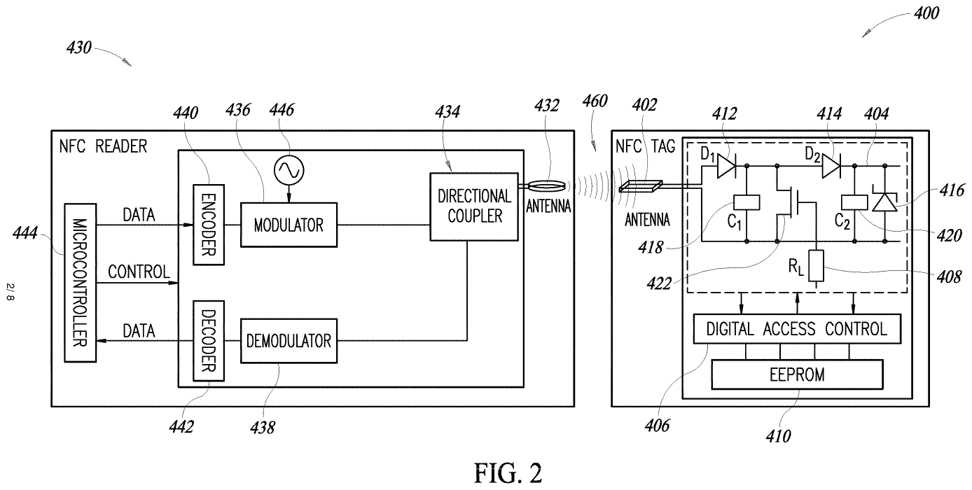

FIG. 2 is a circuit diagram of a passive tag 400 configured to interact with with an active reader 430 over a wireless network 460 (e.g., through a magnetic field). The passive tag 400 may be used as the tags in the systems described in the present disclosure. The tag 400 includes an antenna 402 coupled to a rectifier 404. The rectifier 404 is coupled to a control module 406. A load or resistor 408 is coupled between the rectifier 404 and the control module 406. The control module 406 is coupled to a memory 410. In some examples, the memory may be a non-volatile memory such as an electrically erasable programmable read-only memory (EEPROM) which stores the unique ID of the tag 400 and stores the user data, such as localization information. The control module 406 may be a digital access control which analyzes signals received by the antenna 402 and retrieves the unique ID and the user data of the tag 400 from the memory 410.

The rectifier 404 receives an RF signal from the antenna 402 and converts a portion of the RF signal to a direct current (DC) voltage to turn on the control module 406. In some examples, the rectifier 404 include two diodes 412, 414 (D1 and D2) and a Zener diode 416. Two capacitors 418, 420 (C1 and C2) store enough charge to turn on the Zener diode 416 which provides a constant voltage for the control module 406. The diodes 412, 414 may be low barrier Schottky diodes with a low-threshold, capable to turn on with a low energy RF signal received by the antenna 402. In addition, the rectifier 404 is coupled to the control module 406 by a transistor 422 (e.g., field-effect transistor) that is controlled by the load 408. The transistor 422 and the load 408 may modulate the impedance of the antenna 402 to backscatter a portion of the RF signal that includes UID of the tag 400. The received RF signal may include a command to enable the control module 406 to retrieve the UID of the tag 400 that is stored in the memory 410. In some examples, the retrieved UID may be modulated on a portion of the RF signal to be backscattered by the antenna 402 to the reader 430.

The reader 430 includes an antenna 432 coupled to a directional coupler 434. The directional coupler 434 is coupled to a modulator 436 and a demodulator 438. The modulator 436 and the demodulator 438 are coupled to a processor 444 by an encoder 440 and a decoder 442, respectively. The modulator 436 includes an oscillator 446 to generate a signal with a frequency consistent to the NFC communication protocol (e.g., 13.56 MHz). The directional coupler 434 may direct a signal from the modulator 436 to the antenna 432 in a transmission mode, while directing a received signal from the antenna 432 to the demodulator 438 in a receiving mode (e.g., by disconnecting a path to the modulator 436). The reader 430 may receive power from the vehicle's battery or may have a standalone power supply.

In operation, the processor 444 generates a request signal to detect NFC tags that may be present in a communicable distance. The request signal is encoded by the encoder 440 and modulated by the modulator 436 to transmit though the antenna 432. If a portion of the request signal is backscattered by one or more tags in the communicable distance from the reader 430, then the antenna 432 receives the backscattered signal. When the reader 430 is in the receiving mode, the backscattered signal received by the antenna 432 is directed to the demodulator 438 by the directional coupler 434. The demodulator 438 demodulates the backscattered signal and the decoder 442 decodes the demodulated signal to be processed by the processor 444. The processor 444 may compare the received user data with an inventory to detect the tag 400. In some examples, the processor may send the detected, authorized, confirmed user data to a remote server to confirm the detection process.

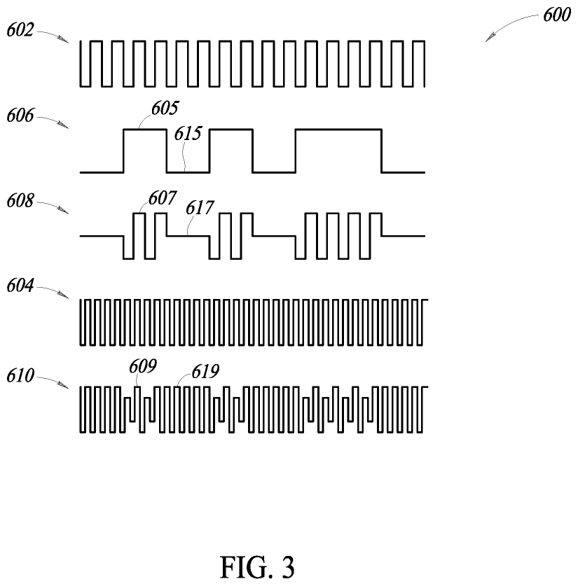

FIG. 2 is one example of the circuitry that may be included in the tags or readers of the present disclosure. FIG. 3 is an example of waveforms that could be implemented in the present disclosure. Other implementation options are envisioned.

FIG. 3 is an example of different waveforms in a modulation system 600 for establishing a communication link (e.g., communication link 106) in an NFC system. The modulation system 600 utilizes a subcarrier signal 602 with a lower frequency compared with a carrier signal 604 to transfer data. In such an NFC system, the carrier signal is typically 13.56 MHz. The frequency of subcarrier signal 602 may be obtained based on the number of binary bits of data to be transferred by the carrier signal 604. For instance, for transferring 16 bits data the frequency of the subcarrier signal 602 is calculated by 13.56 MHz/16 that is about 847 KHz. The higher frequency of the carrier signal 604 is depicted by a denser waveform in a same period of time compared with the subcarrier signal 602. In various embodiments, the shape of the waveform may be the same for both the carrier signal 604 and the subcarrier signal 602.

The subcarrier signal 602 is modulated by a baseband coded signal 606 (based on the data stream to be transferred by the NFC system). The baseband coded signal 606 carries bits of data (e.g., UID of the tags) and modulates the subcarrier signal 602 to generate a modulated subcarrier signal 608. For example, a bit of data 605 in the baseband coded signal 606 modulates the waveform of the subcarrier signal 602 to generate a modulated subcarrier bit of data 607. Thus, the waveform of the modulated subcarrier signal 608 is the same as the subcarrier signal 602 for the bits of data that are in high-logical level, e.g., the bit of data 605. While the waveform of the modulated subcarrier signal 608 is flat for the bits of data that are in low-logical level, such as a low-logical level bit of data 615 which generates a flat waveform 617 corresponding to a zero data.

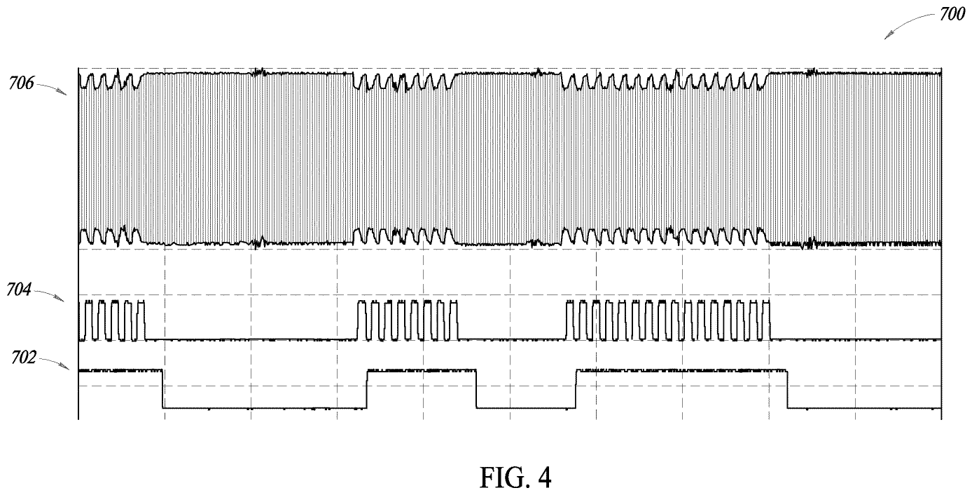

The lower frequency of subcarrier signal 602 compared with the carrier signal 604 benefits generating the modulated subcarrier signal 608 in a frequency spectrum different than the operation frequency of the carrier signal 604. Thus, the modulated subcarrier signal 608 is coupled to a switch of the tags (e.g., the transistor 422 in FIG. 4) to modulate a load (e.g., load 408 of FIG. 4) based on the data from the baseband coded signal 606. Accordingly, the modulated subcarrier signal 608 provides load modulation of the tag in the NFC system in a frequency different than the operation frequency of the carrier signal 604. In a frequency spectrum, the data is transmitted in sidebands of the subcarrier signal 602 instead of occupying sidebands of the carrier signal 604.

For transmitting the data with the carrier signal 604 in the operation frequency of the NFC system (13.56 MHz), the modulated subcarrier signal 608 modulates the carrier signal 604 by load modulation (switching on and off the switch of the tag) to generate a load modulated signal 610. The load modulated signal includes the data from the baseband coded signal 606 which is modulated on the subcarrier signal 602. For instance, the modulated subcarrier bit of data 607 modulates the carrier signal 604 with a waveform such as a portion 609 of the load modulated signal 610. While the flat waveform 617 of the modulated subcarrier signal 608 generates a flat amplitude 619 of the load modulated signal 610.

In various embodiments, a wireless network of the NFC system operates in the frequency range of the carrier signal 604 to exchanges data between the reader and tags. The reader receives the load modulated signal 610 from the tag (which is modulated on the operation frequency of the carrier signal 604) and extracts the data from the load modulated signal 610 by a demodulator and/or decoder. The extracted data is analyzed by a processor to complete a reading process based on the data received from the tag.

FIG. 4 is an example of a modulation system 700 during reading out one or more tags corresponding to an NFC system of the present disclosure. In this embodiment, a baseband coded signal 702 is an indicative signal of the unique ID or user data of each tag in the NFC system. The baseband coded signal 702 is generated based on the data stored in the EEPROM of each tag. Then the baseband coded signal 702 modulates a subcarrier signal to generate a modulated subcarrier signal 704. The modulated subcarrier signal 704 is able to switch on and off the transistor of the tag to generate a load modulated signal 706 on a carrier signal in an operation frequency of the NFC system (13.56 MHz). The load modulated signal 706 has a waveform of the signal which is received by an antenna of the reader (e.g., antenna 432). Amplitude of the load modulated signal 706 is modulated by the modulated subcarrier signal 704 that will be extracted as the reading out data by the processor in the reader. In a same condition, the processor of the reader generates a command by a signal such as the baseband coded signal 702 and modulates subcarrier and carrier signals by the encoder and modulator of the reader (e.g., the modulator 436 and encoder 440). The modulator may include an oscillator (e.g., the oscillator 446) to generate the operation frequency of the carrier signal (13.56 MHz). In this condition, the modulation scheme is a digital modulation such as Amplitude Shift Keying (ASK). In various embodiments, different modulation schemes may be used, such as Phase Shift Keying (PSK) and Frequency Shift Keying (FSK).

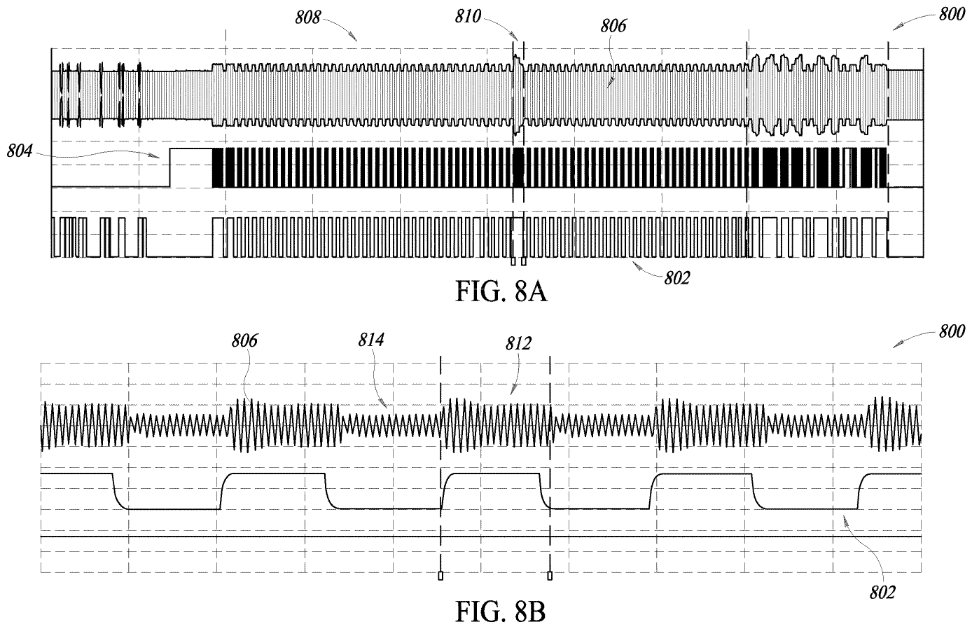

FIG. 8A is an example of the waveform generated by a demodulation system 800 in response to reading out two different tags. For reading out multiple tags, the reader generates a request signal with multiple timing slots corresponding to the number of tags in the NFC system. In a normal operation, for an NFC system with 16 tags, the reader generates the request signal for 16 sequential timing slots. Each tag randomly selects a timing slot to respond to the reader. If selected timing slots for two or more tags overlap in a same timing slot while user data is the same in all the activated tags, the user data is confirmed. Otherwise, if one or more user data being different than the other user data in the same timing slot, it causes a collision during the reading out process. The demodulation system 800 shows a condition, in which two tags are detected with different user data. In this example, the user data of two tags has only one bit difference. In response to detection of the different user data, a controller (e.g., the processor 444 in FIG. 2) detects the one bit collision and executes a program for anti-collision process (e.g., step 510 in FIG. 1). In various embodiments, the different user data may indicate an unauthorized tag in the system and execute the anti-collision process as an anti-fool process prohibiting fraud or subversive actions.

The demodulation system 800 includes a baseband coded signal 802, a subcarrier demodulated signal 804, and a load demodulated signal 806. Two tags are detected in a same timing slot 808. In this embodiment, a timing period 810 shows an example of the collision between two detected tags in which the two tags have only one bit of different data. In response to detection of one bit difference between the user data of two detected tags (in timing period 810), a controller (e.g., the processor 444 in FIG. 2) executes a program for anti-collision process (e.g., step 510 in FIG. 1). In various embodiments, the two detected tags may have more than one bit difference in user data. In the example described herein, only one bit difference is considered to test the accuracy of the detecting an unauthorized tag, where the smallest possible difference between the user data of the tags is one bit.

FIG. 8B is a zoomed view of the baseband coded signal 802 and the load demodulated signal 806 described in FIG. 8A, for a condition that the user data of the detected tags are the same and there is no collision in the demodulation system 800.. A duty cycle, that is a timing ratio between on state 812 and the load demodulated signal 806 (accumulation of the on state 812 and off state 814), shows an acceptable quality due to the timing intervals between the timing slot of reading out multiple tags. The waveform of the load demodulated signal 806 confirms that on state 812 and off state 814 are detectable when multiple tags are detected in different timing slots with the same user data.

Returning to FIG. 1, at 508, if the processor detects there is only one unique ID in each timing slot and there is no collision, then the processor ends gathers the user data and ends the reading/activating process at 512. In some embodiments, if the processor detects multiple unique IDs in the same timing slot having the substantially same user data, then the processor may not detect a collision and ends the process at 512.

If there are multiple unique IDs with different user data, the processor executes a program for anti-collision, at 510. During the anti-collision process, the processor compares all the detected unique IDs in all the timing slots with the inventory. The inventory includes either a single user data reference or a plurality of authorized user data references (such as a plurality of authorized parking locations). Thus, the processor compares all the different user data from the detected tags with the inventory in one timing cycle to identify an authorized tag. In some examples, the substantially same user data may be an SID corresponding to a parking location. If there are other detected user data that are not matched with the inventory, then the processor blocks or filters these tags from the communication network and ends the process at 512.

At 512, in an alternative embodiment, if the processor detects a first tag that matches the user data and then detects any second tags that also match with the same user data, then the processor places the second tags in a sleep mode. The processor can generate a sleep mode command and transmit to the second tags to activate in a sleep mode (unresponsive) for a period of time to avoid further collision in timing slots during the process. When the processor detects that any tag has authorized user data, the processor communicates a confirmation signal. In some embodiments, such as in the parking example use case, the confirmation signal can be communicated with a remote server, such as the e-bike service provider's servers for parking and payment confirmation. In some examples, the remote server may complete a rental transaction (e.g., for a rental e-bike) in response to receiving the confirmation signal from the reader.

The present disclosure can be integrated in a variety of use cases. A couple of smart parking examples are described below. These examples are no exhaustive.

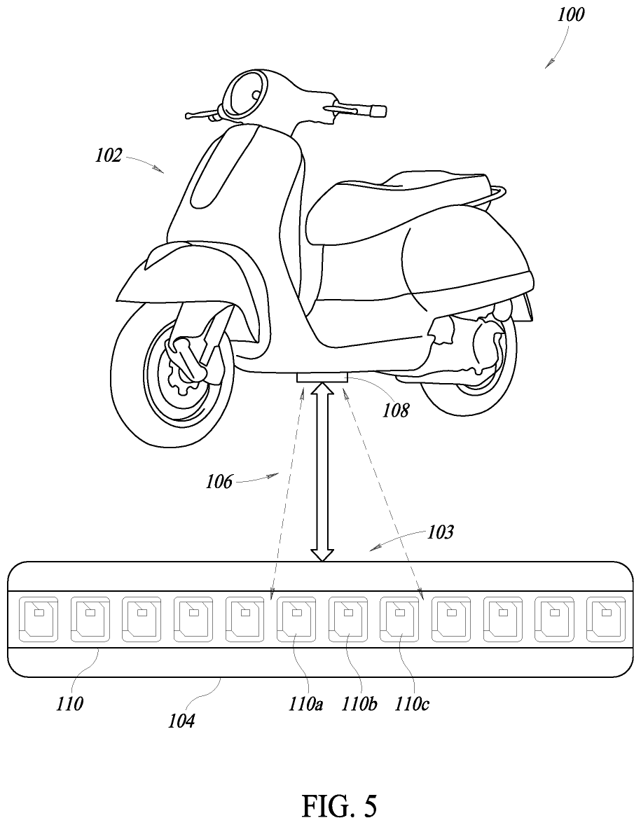

FIG. 5 is a smart parking system 100 for an electric bike (e-bike) 102 or other vehicles, such as rentable scooters, bikes, or other people moving options. The e-bike 102 is configured to automatically detect and identify if a parking location 104 is an acceptable location for parking the e-bike 102 by activating a plurality of tags 110 that are within a vicinity of a reader 108 coupled to the bike. The reader (or initiator) 108 is positioned or otherwise coupled to a bottom surface of the e-bike 102 that is configured to wirelessly communicate with a plurality of tags (or listening devices) 110 fixed to the parking location 104 through a near field communication (NFC) system. This NFC system allows establishing a communication link 106 between two wireless components (the reader 108 and each tag of the plurality of tags 110) only when the two wireless components are within a communicable distance. The communicable distance for the NFC system, where the reader 108 is configured to activate passive radio radiofrequency identification (RFID) tags (e.g., the plurality of tags 110), is less than about 20-30 centimeters. The passive tags are activated by a signal transmitted by the reader. The passive RFID tags may not include a battery and instead are only activated or powered on when within a specific distance of the NFC reader.

By utilizing the NFC system to manage the smart parking system 100, a distance between the e-bike 102 and the parking location 104 may be below one meter (e.g., 20-30 centimeters) to sufficiently establish the communication link 106 (e.g., through a magnetic field).

The reader 108 is attached to the e-bike 102 facing the ground. The plurality of tags 110 are arranged in a fixed location along the parking location 104. For example, the plurality of tags 110 may be attached to the road or a hard surface, such as asphalt, as a strip of distinct tags. In some embodiments, the plurality of tags are spaced equidistance apart. The reader 108 is configured to activate ones of the plurality of tags 110 when an operator moves the e-bike 102 over a portion of the plurality of tags 110. The reader 108 provides the sufficient energy to the subset of tags to be activated.

In some examples, the NFC system may operate in an RF backscattering mode, where the reader 108 transmits an RF signal to a subset of tags of the plurality of tags 110 that are in an area 103 that corresponds to a coverage range of the RF signal of the reader 108. In this example, there are three tags 110a-110c that are within the area 103 that will be activated by the reader 108 when the operator moves the e-bike 102 to overlap with the parking location 104. The backscattered signal includes user data. The plurality of tags may be spaced from an adjacent tag by 1 inch to up to 12 inches or more. A spacing of the tags is determined by an end use of these methods and systems. For example, scooters have a smaller width than some e-bikes, which may benefit from tags being closer to each other than an e-bike system. Alternatively, each tag may be spaced from an adjacent tag by a distance equal to a tag. The system is configured to address situations where the NFC reader detects at least two tags during a scanning or activation process.

In some embodiments, the area 103 may be about 30 centimeters (in diameter). When the reader 108 is positioned close enough to the plurality of tags 110, the reader communicates with a number of tags which are in the communicable distance to establish NFC communication link 106. The reader 108 will receive the identification or user data from all tags that are activated in the area 103. The reader 108 is in communication with a remote server and ultimately with the operator to provide an indication of the appropriateness of the parking location 104. The remote server may communicate directly with the reader or may be coupled to the reader through an application on the user's mobile communication device, such as a phone. In response to a determination of the acceptable parking location 104, the operator may receive a notification through an application that “Yes, this is an OK parking spot” or “No, parking spot detected”. Also, the parking localization may be stored at the server level, in order to help to have a complete information of the localization of the parked vehicles of shared vehicle system.

If the operator positions the e-bike 102 in an unauthorized location, such as in a parking location for a different rental company that has a plurality of fixed tags in the parking location, the reader 108 will be able to activate the passive tags of that parking location (other than the parking location 104), but will not receive acceptable identification data from the tags. There may be a plurality of strips of tags in a parking area, one area being associated with the rental company used by the operator and other areas for other rental companies. If the operator moves the e-bike 102 over an unauthorized parking area, the reader 108 and the NFC system will notify the operator that the location is not an appropriate location.

Each NFC tag of the plurality of tags 110 includes a unique identification (UID) that is readable by the reader 108. When the reader 108 receives the backscattered signal from multiple tags at a same time (cross-read of multiple tags), it may result in an interference (collision) between the tags. The polling by the NFC reader will perform an anti-collision process only when the user data in simultaneously activated tags is not the same. If the user data is the same in the activated tags, the user data is confirmed and the processor executes a next step in the end process.

The unique ID is unique for each tag. The user data stored in tags that are within a vicinity of each other, as determined by an end use, is the same or substantially the same, such as information about parking localization. The read command initiated by the NFC read is for reading the user data, not necessarily the unique ID. This method allows for the “read” command to periodically be sent out, removing the other commands to check for the unique IDs or other tag presence.

This feature provides an opportunity for the reader 108 to identify the acceptable location of the parking location 104 even where a cross-read exists between the multiple tags having the substantially same identification (e.g., tags 110a-110c). In a case which the anti-collision process is performed, it takes shorter time compared with the conventional method, due to confirming all the detected tags with the substantially same identification in a single timing cycle. The memory bits of the user data in each of the plurality of tags are within 1-4 bits of each other and in some embodiments, these improvements are achieved by each of the tags in the parking location having the same or substantially the same identification data (within one or two bits different). Each of the tags includes information to identify the parking location such as by a station identification (SID). Hence, the NFC system avoids applying or performing the anti-collision process when multiple tags that are detected in the area of the reader, i.e. in a same timing slot, as each of the tags has the substantially same data stored (parking location information). Accordingly, the processor detects a collision only when an unauthorized tag (e.g., a tag that is not designated to the parking location of the particular rental company) is in a communicable distance from the reader. The unauthorized tags have different identification data from each other or from the authorized tags in the same area.

In general, an anti-collision process includes an inventory of authorized NFC tags of the system (e.g., the smart parking system 100). The inventory may include a list of authorized parking locations to compare with the user data from the authorized NFC tags, the inventory is stored in a memory of the processor of the reader or in a remote server.

The present disclosure is broadly directed to an active near field communication (NFC) reader that is configured to interact with a plurality of passive NFC devices or tags that are in close proximity to each other or otherwise within a vicinity of each other. Each of the NFC devices or tags have a same identification or similar identification reference in a memory.

In various embodiments, the NFC reader may detect the plurality of NFC tags by transmitting a request signal and receiving one or more returned signals from the plurality of NFC tags. In some examples, the plurality of NFC tags may be passive and capable to be activated by harvesting energy from the request signal that is transmitted by the NFC reader.

In general, if the NFC reader receives the backscattering signal from multiple NFC tags at the same time, an interference (collision) may prevent a successful detection of the NFC tags in the NFC system. Typically, an anti-collision process may provide a desired resolution of the NFC tags' detection by matching detected identification data with an inventory mask (e.g., inventory of authorized NFC tags) to determine each NFC tag which is within the plurality of NFC tags. However, this anti-collision process results in a delay in a reading out process of the NFC tags due to a multi-step matching identification data with the inventory mask.

In the present disclosure, the identification data of the plurality of NFC tags in close proximity to each other are substantially the same. Thus, an anti-collision process may be avoided unless an NFC tag with a different identification data than the plurality of NFC tags is within the range of the active NFC reader. In this case, the anti-collision process will only be activated if the NFC reader detects identification data that is not substantially the same identification data as the other NFC tags within the range of the NFC reader.

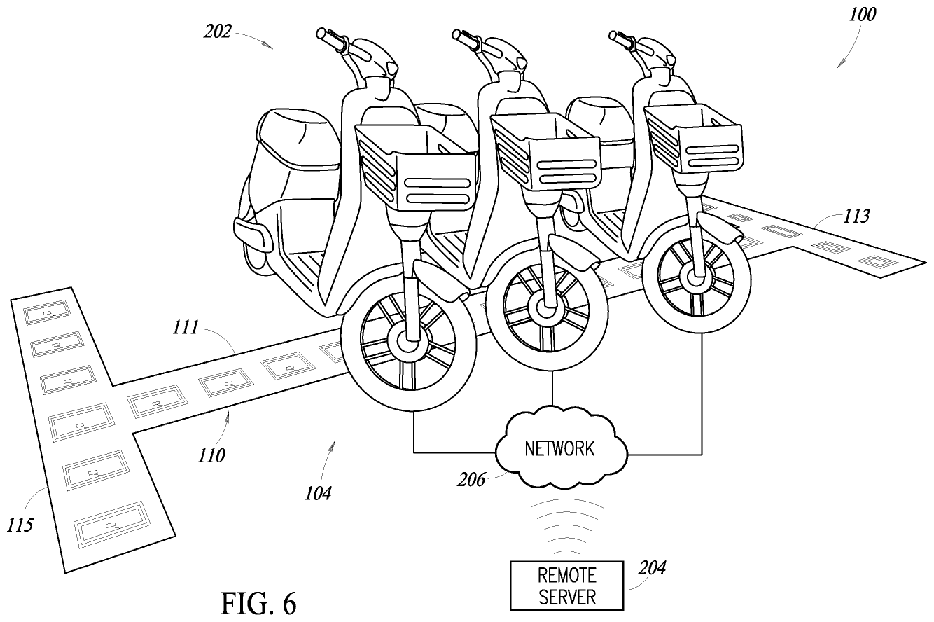

FIG. 6 shows an example of the smart parking system 100 where a plurality of e-bikes 202 are parked in the designated parking location 104. Each e-bike of the plurality of e-bikes 202 may be represented by the e-bike 102 with the reader 108 as described in FIG. 5. When an operator of each e-bike 202 moves the e-bike over a portion of the plurality of tags 110, the reader 108 on the e-bike detects one or more tags of the plurality of tags 110 and in response notifies the operator about the e-bike that is parked in an authorized parking location 104. In some examples, notification of the parking may complete a rental transaction of the e-bike. The system may also be configured to notify the operator if the bike is not in an authorized parking location, such as a location owned or managed by a different company or provider.

A maximum number of the plurality of e-bikes 202 that can be parked in the parking location 104 may depend on the number of authorized tags fixed in the parking location 104. For instance, the plurality of tags 110 may include 16 tags that provides a capacity of parking 16 e-bikes in the parking location 104. Alternatively, there may be significantly more tags in a parking area than number of bikes that can fit in the parking area. For example, instead of only being a strip of tags, like the tags 110, an area may be filled with tags in an array so that the e-bikes may be parked in a zone as opposed to in a line.

In FIG. 2, the plurality of tags 110 are arranged in an I or H shape with a central extension over which the e-bikes are illustrated and a first and second side extensions 113, 115. The first side extension 113 is spaced from the second side extension 115 by the central extension 111, which is transverse or perpendicular to the first and second side extensions. In some embodiments, the operator could park the e-bike over one of the first or second side extensions. Various orientations of the plurality of tags can be selected to meet the design parameters of the final system.

The plurality of tags 110 are passive, thus the parking location 104 is capable of operating without any external energy sources. Each e-bike of the plurality of e-bikes 202 provides the sufficient energy for the reader 108 to communicate with one or more tags of the plurality of tags 110 in the parking location 104. Each e-bike includes a main battery which provides electrical energy for operation of the e-bike in addition to the source of energy required for the reader 108. In some examples, the e-bike may include a spared battery different than the main battery, which provides the required energy for the reader 108.

In some examples, each e-bike of the plurality of e-bikes 202 includes a communication interface or a transceiver coupled to the reader 108. The communication interface wirelessly communicates with a server 204 over a network 206. The network 206 may include a wireless local area network (WLAN), e.g., Wi-Fi, a cellular network (e.g., 5G, 4G, LTE), or even a short-range communication network such as Bluetooth. The reader 108 may transmit the detected user data from one of the plurality of tags 110 to the server 204 to confirm the parking location 104 with an inventory stored in the server 204.

In one embodiment, the tags may be programmed by the rental company to change the unique identification (UID) of each tag to support in the efficient reading of a plurality of tags for parking. The present application has focused on unique IDs with the same user data. Different combinations of programmable unique IDs and the same user data in tags are envisioned. For example, with programmable unique IDs, the NFC reader can be configured to read and efficiently process a plurality of tags that have the same unique programmed IDs.

In addition, the reader 108 may combine an identification data of the e-bike within the detected user data and transmit the combined data to the server 204. In this condition, the server 204 may assign the detected user data to the identification data of the e-bike and send a notification to the operator of the e-bike through an application program (e.g., installed on a smart device of the operator). In addition, the server 204 may retrieve a history of the identified e-bike and the operator of the identified e-bike to complete a rental transaction when confirming the authorized parking location 104. The server 204 may send a confirmation signal to the reader 108 to notify the operator of the e-bike about the successfully positioning the e-bike in the authorized parking location 104. In some examples, the notification may be displayed to the operator by a display screen on the e-bike or on the user's mobile device, such as on a display. The remote server could be within a proximity to the parking location, such as in an adjacent building or could be a remote cloud storage device.

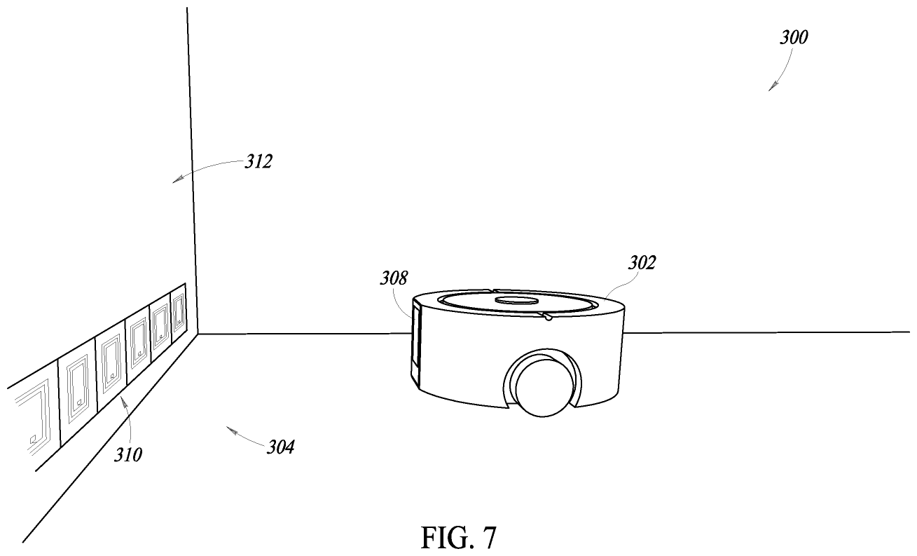

The NFC system of smart parking system 100 may be utilized in various automated management systems such as in a factory or in smart-home applications, such as a robotic vacuum. For instance, as shown in FIG. 7, a positioning management system 300 utilizes an NFC system, to position an unmanned vehicle 302 (e.g., a robot) in an authorized position 304. A reader 308 is on the unmanned vehicle 302 detects a subset tags of a plurality of tags 310 arranged along a wall 312. When the unmanned vehicle 302 is close enough to a portion of the plurality of tags 310, then the reader 308 detects a subset tags of the plurality of tags 310. The reader 308 may activate the tags and collect the user data to a server that is located within the same building to confirm the position 304 by the inventory stored in the server. The reader 308 can include an inventory to compare with the user data of the detected tags. By confirming the position of the unmanned vehicle 302, the server or an internal processor of the unmanned vehicle 302 may execute a standby program to stop the unmanned vehicle 302 in the authorized position 304. This may be utilized as a tracking system for the different vehicles. In an alternative example, the plurality of tags within a parking location (e.g., plurality of tags 110) may include a read block in addition to the unique ID (UID). The read block includes the same identification data, e.g., SID, for the plurality of tags in the parking location. In this condition, the command causes to retrieve the read block of each tag to be backscattered to the reader without retrieving the UID of each tag.

In an alternative example, if the command of the reader is to retrieve only the read block data, then the processor analyzes the backscattered signal to detect if a read block exists corresponding to the parking location. If the reader only detects read block data instead of UID, then the processor compares read block data with an inventory of SID instead of UID.

A method may be summarized as including transmitting, by a movable near field communication (NFC) reader, a request signal that includes a read command; receiving by the movable NFC reader a first signal in a first timing slot in response to activating a first NFC tag; receiving a second signal in a second timing slot in response to activating a second NFC tag, the first and second NFC tags being in a fixed location, the first signal including first identification data about the fixed location and the second signal including second identification data about the fixed location; determining with the movable NFC reader if the first and second identification data are substantially the same; and transmitting a confirmation signal in response to determining the first and second identification data are substantially the same.

The determining may include comparing the first and second identification data with a station identification (SID) stored in the NFC reader, the substantially same identification includes the SID.

Transmitting may include a read command to retrieve two blocks of data from a memory of each of the first and second NFC tags, the memory of each of the first and second NFC tags includes four blocks of data, the two retrieved blocks are identical for the first and second NFC tags.

The method may further generate an acceptable location signal in response to the first or second identification data matching the SID; and may transmit the acceptable location signal to a remote server.

The SID may be stored in the movable NFC reader or in the remote server.

The method may further complete a rental transaction in response to receiving the acceptable location signal by the remote server.

The NFC reader may be attached to an electric bike or scooter.

The NFC reader may be attached to an unmanned movable device.

The method may further include activating an anti-collision process by determining the first timing slot overlapping with the second timing slot; and determining with the movable NFC reader that the first and second identification data are different.

A timing from the transmitting the request signal to the transmitting the confirmation signal may be equal to or less than 100 milliseconds.

A near field communication (NFC) system may be summarized as including a plurality of NFC tags attached at a fixed location, each NFC tag of the plurality of NFC tags includes: a first antenna configured to receive a request signal; a rectifier configured to rectify a portion of the request signal, the rectifier is configured to activate the NFC tag; a memory configured to store identification data about the fixed location; and a processor configured to detect a command from the request signal, retrieve the identification data from the memory, and transmit the identification data, wherein the identification data is substantially the same for the plurality of NFC tags.

The memory may be a non-volatile memory.

The identification data of each NFC tag may include 8 bytes of data, one bit of the 8 bytes of data is different for the plurality of NFC tags.

The substantially same identification data may be an indicative data set corresponding to the fixed location.

The fixed location may be a parking location, and a movable reader may detect the parking location by detecting one or more NFC tags of the plurality of NFC tags.

The movable reader may include a processor configured to: extract identification data of the detected NFC tags; compare the extracted identification data with a station identification (SID), the substantially the same identification data includes the SID; and execute an anti-collision process if two or more extracted identification data are in a same timing slot and at least one of the extracted identification data is different than the SID.

A method may be summarized as including positioning a movable near field communication (NFC) reader in a fixed location; transmitting by the movable NFC reader a request signal to activate a plurality of NFC tags along the fixed location; reading out identification data from the plurality of NFC tags, the identification data being substantially the same for the plurality of NFC tags; indicating, by the movable NFC reader, the fixed location from the identification data of the plurality of NFC tags; and notifying an operator about the fixed location.

The method may further include activating an anti-collision process if the movable NFC determines at least one identification data of the plurality of NFC tags is different than the substantially the same identification data.

A timing from the positioning the movable NFC reader to the notifying the operator may be equal to or less than 100 milliseconds.

Transmitting the request signal may include transmitting the request signal in a plurality of timing slots, number of plurality of timing slots being the same as number of the plurality of NFC tags.

The present disclosure is directed to a method that includes reading a plurality of passive near field communication (NFC) devices within a vicinity of an NFC reader and transmitting a confirmation signal in less than or equal to 100 milliseconds by: activating the plurality of passive NFC devices at the same time with a same signal; receiving user data from the plurality of activated passive NFC devices; comparing received user data to each other; only activating an anti-collision process in response to the received user data being at least one bit different from each other; and processing the received user data without activating the anti-collision process if the received user data is the same. The processing being in a processor in the NFC reader, the processing including comparing the received user data from one of the plurality of passive NFC tags with a reference data in a memory in the NFC reader. The transmitting the confirmation signal is in response to when the received user data matches the reference data. The timing from the activating to the transmitting the confirmation signal being less than or equal to 100 milliseconds.

The present disclosure is directed to wirelessly communicating between an active near field communication (NFC) reader and a plurality of first passive NFC devices that are within a vicinity of the NFC reader, the plurality of first passive NFC devices including user data in a memory of each of the first passive NFC devices, the communicating including: transmitting an activation signal from the NFC reader to the plurality of first passive NFC devices; receiving a response from at least two of the first passive NFC devices; and activating an anti-collision process only in response to the user data from the at least two of the first passive NFC devices having more than one bit of data different from each other. The comparing the user data from a first one of the first passive NFC devices without activating the anti-collision process with authorized reference data. The transmitting an authorization signal in response to the user data matching the authorized reference data. The activating the anti-collision process only in response to the user data from the at least two of the first passive NFC devices having at least one bit of data different from each other. The user data is a parking station identifier and the NFC reader is on a mobile vehicle. The communicating includes comparing the user data received from a first one of the first passive NFC devices to an authorized stored user data in the NFC reader.

The present disclosure is directed to a near field communication (NFC) system having an NFC reader that includes: a memory that includes authorized user data; a transmitter configured to output a read signal to a plurality of first passive NFC devices, each device having a first user data in a memory; a receiver configured to receive the first user data from at least one of the first passive NFC devices; and a comparer configured to compare the authorized user data with the received first user data. The first user data is the same in each one of the plurality of first passive NFC devices. The first user data is substantially the same in each one of the plurality of first passive NFC devices, the first user data being within 1 to 4 bits different in each of the first passive NFC devices. The receiver is configured to receive second user data from a second passive NFC device, the second user data being substantially different from the first user data; and the NFC reader includes a processor configured to initiate an anti-collision process only in response to the receiving of the second user data.

The present disclosure is directed to a method that includes positioning a near field communication (NFC) reader in a location; activating a plurality of NFC devices along the location by transmitting a request signal from the NFC reader; reading first identification data from a first one of the plurality of activated NFC devices, the first identification data being substantially the same for the plurality of NFC devices; comparing, by the NFC reader, the first identification data with a reference location; and transmitting an authorization signal in response to the first identification data matching the reference location. The method includes activating an anti-collision process in response to reading second identification data from a second one of the NFC devices, the second identification data being substantially different from the first identification data, the activating the anti-collision process being before the comparing. The transmitting the authorization signal includes transmitting the authorization signal to a remote server. A timing from the positioning the NFC reader to the transmitting the authorization signal is equal to or less than 10 milliseconds.

The present disclosure is directed to a near field communication (NFC) system that includes: a plurality of first passive NFC devices, each passive NFC device storing a same first user data in memory; an NFC reader that includes: a transmitter configured to output an activation signal to the plurality of first passive NFC devices; a receiver configured to receive a response from at least one of the first passive NFC devices; an anti-collision module configured to performed an anti-collision process in response to the receiver receiving the response from the at least one of the first passive NFC device and a second response that includes different user data from the first user data; a retrieving module configured to retrieve the user data from the at least one of the first passive NFC devices without activating the anti-collision module. The NFC reader includes a processor that includes the anti-collision module and the retrieving module, the processor is configured to compare the retrieved user data with reference user data from a memory in the processor, and the processor is configured to transmit an authorization signal in response to the retrieved user data matching the reference user data. The NFC reader is configured to transmit the activation signal and transmit the authorization signal in less than or equal to 100 milliseconds.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
reading a plurality of passive near field communication (NFC) devices within a vicinity of an NFC reader and transmitting a confirmation signal by:
activating the plurality of passive NFC devices at the same time with a same signal;
receiving user data from the plurality of activated passive NFC devices;
comparing received user data to each other;
only activating an anti-collision process in response to the received user data being at least one bit different from each other; and
processing the received user data without activating the anti-collision process if the received user data is the same.

2. The method of claim 1 wherein the reading and transmitting occur in less than or equal to 100 milliseconds and the processing being in a processor in the NFC reader, the processing including comparing the received user data from one of the plurality of passive NFC tags with a reference data in a memory in the NFC reader.

3. The method of claim 2 wherein the transmitting the confirmation signal is in response to when the received user data matches the reference data.

4. The method of claim 3 wherein the timing from the activating to the transmitting the confirmation signal being less than or equal to 100 milliseconds.

5. A method, comprising:
wirelessly communicating between an active near field communication (NFC) reader and a plurality of first passive NFC devices that are within a vicinity of the NFC reader, the plurality of first passive NFC devices including user data in a memory of each of the first passive NFC devices, the communicating including:
transmitting an activation signal from the NFC reader to the plurality of first passive NFC devices;
receiving a response from at least two of the first passive NFC devices; and
activating an anti-collision process only in response to the user data from the at least two of the first passive NFC devices having more than one bit of data different from each other.

6. The method of claim 5 wherein the communicating includes comparing the user data from a first one of the first passive NFC devices without activating the anti-collision process with authorized reference data stored in a memory of the NFC reader.

7. The method of claim 6 wherein transmitting an authorization signal in response to the user data matching the authorized reference data.

8. The method of claim 6 wherein the activating the anti-collision process only in response to the user data from the at least two of the first passive NFC devices having at least one bit of data different from each other.

9. The method of claim 6 wherein the user data is a parking station identifier and the NFC reader is on a mobile vehicle.

10. The method of claim 6 wherein the communicating includes comparing the user data received from a first one of the first passive NFC devices to an authorized stored user data in the NFC reader.

11. A near field communication (NFC) system, comprising:
an NFC reader that includes:
a memory that includes authorized user data;
a transmitter configured to output a read signal to a plurality of first passive NFC devices, each device having a first user data in a memory;
a receiver configured to receive the first user data from at least one of the first passive NFC devices; and
a comparer configured to compare the authorized user data with the received first user data.

12. The system of claim 11 wherein the first user data is the same in each one of the plurality of first passive NFC devices.

13. The system of claim 11 wherein the first user data is substantially the same in each one of the plurality of first passive NFC devices, the first user data being within 1 to 4 bits different in each of the first passive NFC devices.

14. The system of claim 11 wherein the receiver is configured to receive second user data from a second passive NFC device, the second user data being substantially different from the first user data; and the NFC reader includes a processor configured to initiate an anti-collision process only in response to the receiving of the second user data.

15-21. (canceled)

22. The system of claim 11, wherein the comparer is configured to compare the user data from a first one of the first passive NFC devices without activating an anti-collision process with authorized reference data stored in a memory of the NFC reader.

23. The system of claim 11 wherein the NFC reader is configured to output an authorization signal in response to the user data matching the authorized reference data.

24. The system of claim 11, wherein the NFC reader is configured to activate an anti-collision process in response to the user data from the at least two of the first passive NFC devices having at least one bit of data different from each other.

25. The system of claim 11, wherein the user data is a parking station identifier and the NFC reader is on a mobile vehicle.

26. The system of claim 11, wherein the communicating includes comparing the user data received from a first one of the first passive NFC devices to an authorized stored user data in the NFC reader.

27. The system of claim 11, wherein the NFC reader is configured to activate an anti-collision process in response to reading second identification data from a second one of the NFC devices, the second identification data being substantially different from the first identification data, the activating the anti-collision process being before the comparing.
